(19) United States
(12) Patent Application Publication
(10) Pub. No.: US 2005/0150249 A1
(43) Pub. Date: Jul. 14, 2005

(54) Heat exchanger for refrigerator and method for manufacturing refrigerant tube of the same

(76) Inventors: Sam Chul Ha, Kyongsangnam-do (KR); Jong Min Shin, Busankwangyok-shi (KR); Bong Jun Choi, Kyongsangnam-do (KR); Cheol Hwan Kim, Kyongsangnam-do (KR); Young Hwan Ko, Seoul (KR); Young Jeong, Kyongsangnam-do (KR); Seong Hai Jeong, Kyongsangnam-do (KR)

Correspondence Address: FLESHNER & KIM, LLP, P.O. BOX 221200, CHANTILLY, VA, 20153, US

(21) Appl. No.: 10/513,419

(22) PCT Filed: May 29, 2002
(86) PCT No.: PCT/KR02/01017

(51) Int. Cl. F28F 13/18; F25B 39/02; B23P 15/26; F28F 19/02; B21D 53/06

(52) U.S. Cl. 62/515; 165/133; 29/890.047

(57) ABSTRACT

A heat exchanger for a refrigerator is disclosed, which has a simple structure, an improved heat exchanging efficiency, and an operating reliability. In the heat exchanger including a refrigerant tube (10) having a plurality of straight parts (11) and a plurality of curved parts (12) which connect the straight parts; and a plurality of fins (20) coupled to the straight parts (11) respectively through a plurality of inner through holes (21), the refrigrant tube (10) has a joining portion of the curved parts (12) and the straight parts (11) coated with a metal layer (110).

### TECHNICAL FIELD

The present invention relates to a fin tube type heat exchanger, and more particularly, to a heat exchanger applied to a refrigerator for producing cooled air supplied to a refrigerating chamber and a freezing chamber.

### BACKGROUND ART

In general, other than the refrigerating chamber and the freezing chamber formed separated from each other, the refrigerator is provided with a so called machine room in a lower part of the refrigerator, and air flow passages in rear parts of, and in communication with, the refrigerating chamber and the freezing chamber. The heat exchanger (evaporator) is fitted together with a blower in the air flow passage, for supplying cooled air to the refrigerating chamber and the, freezing chamber in association with a compressor and a condenser in the machine room. That is, the high temperature, high pressure refrigerant supplied through the compressor and the condenser is evaporated in the evaporator, and latent heat of the vaporization cools down environmental air. The blower keeps circulating air throughout an inside of the refrigerator, to supply air cooled through the heat exchanger to the refrigerating chamber and the freezing chamber.

The foregoing related art heat exchanger for a refrigerator is illustrated in FIGS. 1 and 2;

Referring to FIGS. 1 and 2, the related art heat exchanger is provided with a refrigerant tube 1 for refrigerant flow, and a plurality of fins 1 fitted to the refrigerant tube 1 at fixed intervals in parallel with one another.

In more detail, in the heat exchanger, one line of the refrigerant tube 1 forms one column, to which the fins 2 are fitted. FIG. 2 illustrates two lines of refrigerant tubes 1 forming two columns.

Referring to FIG. 2, the fin 2, substantially in a small plate form, has through holes 2a for the refrigerant tube 1. That is, the related art heat exchanger has discrete fins 2 separable into individual pieces. Therefore, the fins 2 form discrete heat exchange surfaces along a length direction of the heat exchanger in a state the fins 2 are fitted to the refrigerant tube 1.

Moreover, a large amount of moist contained in air in the refrigerator is frosted on surfaces of the heat exchanger due to an ambient temperature, which is sub-zero, and interferes the air flow. Therefore, in general, a defroster 3 for melting the frost is provided to the heat exchanger, and a defrosting process is carried out during operation separately, by using the defroster.

The heat exchanger is fitted in vertical position in the foregoing air flow path, such that the air in the refrigerator enters into the heat exchanger from below, and exits from top as shown in arrows after being heat exchanged.

However, the foregoing related art heat exchanger has the following problems even if the heat exchanger is applied to most of refrigerators, currently.

For an example, the fins 2 are fitted to the refrigerant tube 1 one by one along the refrigerant tube 1 as the fins 2 are discrete and individual. The fins 2 are arranged along the refrigerant tube 1 at intervals different from one another in an upper part and a lower part of the heat exchanger. That is, a flow resistance caused by growth of the frost deteriorates performance of the flow resistance, the fins 2 are arranged at greater intervals in the lower part, the air entrance side where much frost is formed, than the upper part.

Moreover, the water formed by the defrosting remains at lower edges 2b of each fins 2 as comparatively big water drops owing to surface tension, and acts as nuclei of frost growth again in a following refrigerator operation (a cooling process). Therefore, as shown, it is required that the defroster 3 is in contact with all the lower edges 2a without exception.

At the end, the use of such discrete type fins leads a structure of the related art heat exchanger complicate actually, and assembly of which is not easy, too. Moreover, it is preferable that the heat exchanger for the refrigerator has a small size and a high efficiency as the heat exchanger is located in a comparatively small air flow passage. However, due to the foregoing various problems, design change for optimization of the related art heat exchanger is not easy.

### DISCLOSURE OF INVENTION

An object of the present invention, devised for solving the foregoing problems, lies on providing a heat exchanger for a refrigerator, which has a simple structure and easy to fabricate.

Another object of the present invention is to provide a heat exchanger for a refrigerator, which has an improved heat exchange performance.

Further object of the present invention is to provide a heat exchanger for a refrigerator, which has reliability for a long time use.

To achieve the objects of the present invention, there is provided a heat exchanger for a refrigerator including a refrigerant tube having a plurality of straight parts and a plurality of curved parts each connecting the straight parts, and a plurality of fins for coupling with the straight parts of the refrigerant tube through a plurality of through holes therein, wherein the refrigerant tube includes coupled parts of the straight parts and the curved parts coated with a metal layer.

The metal layer is coated at least ends of the straight parts, and preferably the whole curved parts and ends of the straight parts corrected to the curved parts. In more detail, the metal layer is extended by 15 min from the end of the straight part toward a center of the straight part.

The coupled part includes an expanded part at the end of the straight part, an inserted part which is a part of the curved part inserted in the expanded part of the straight part, and a metallic stuffing material stuffed in a space between the expanded part and the inserted part.

Preferably, the expanded part has an inside diameter 1.3 times of an initial inside diameter of the straight part, and more preferably, the expanded part has an inside diameter 1.35-1.45 times of an initial inside diameter of the straight part.

Preferably, the expanded part has a length of minimum 3 mm, and preferably a gap between an inside surface of the expanded part and the outside surface of the inserted part is below 1 mm.

Preferably, the refrigerant tube is formed of aluminum, and the metal is zinc. Moreover, the refrigerant tube further includes a corrosion resistance layer coated on the metal layer.

In another aspect of the present invention, there is provided a method for fabricating a refrigerant tube of a heat exchanger for a refrigerator, including the steps of expanding ends of straight parts of the refrigerant tube such that each of the ends has an inside and an outside diameters, inserting ends of curved parts in expanded ends of the straight parts, to pre-couple the straight parts and the curved parts, and coupling the pre-coupled straight parts and the curved part such that a metal layer covers a coupled part of the straight parts and the curved parts.

It is preferable that the method for fabricating a refrigerant tube of a heat exchanger for a refrigerator, further includes the steps of coupling the straight parts and fins in advance before the step of expanding ends of straight parts.

The ends of the curved parts are press fit to ends of the straight parts partially when the curved parts are inserted in the straight parts.

The coupling step includes the steps of dipping the pre-coupled curved parts and straight parts in molten metal, and taking the dipped curved part and the straight parts out of molten metal.

The pre-coupled curved parts and the straight parts are dipped into the molten metal starting from the curved parts.

The coupling step may further include the step of pre-heating the curved parts and the straight parts before the dipping step.

Preferably, the coupling step may further include the step of pre-heating the curved parts and the straight parts before the dipping step, or the coupling step may further include the step of applying a high frequency wave to the molten metal during the dipping step. The method for fabricating a refrigerant tube of a heat exchanger for a refrigerator, may further includes the steps of cooling down the coupled curved parts and straight parts after the coupling step, and blowing air into insides of the coupled straight parts and curved parts after the coupling step.

The application of the straight fins facilitates simple structure and assembly process of the heat exchanger, and improves a heat exchange performance. Together with this, the use of aluminum refrigerant tube and uniform welding of the coupled part facilitated by the dipping welding permits a low production cost, an improved corrosion resistance, and a stronger bonding strength, and prevention of defects caused by leakage.

### BRIEF DESCRIPTION OF DRAWINGS

The accompanying drawings, which are included to provide a further understanding of the invention, illustrate embodiments of the invention and together with the description serve to explain the principles of the invention:

In the drawings:

FIG. 1 illustrates a front view of a related art heat exchanger for a refrigerator;

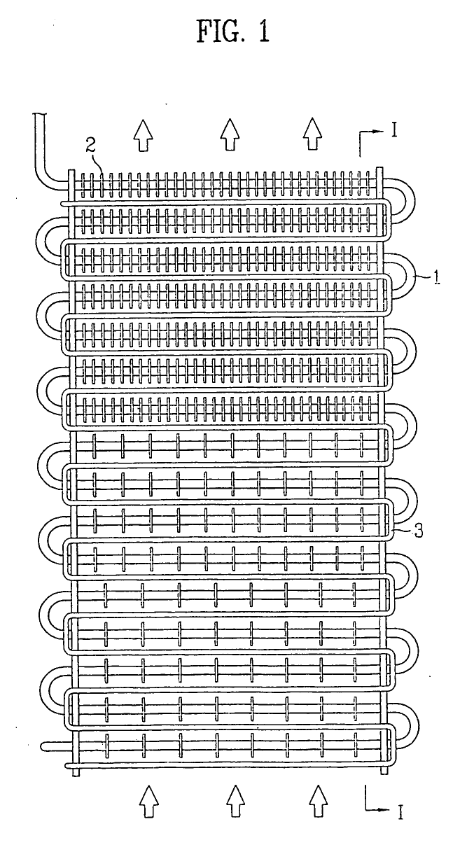

FIG. 2 illustrates a section across a line I-I in FIG. 1;

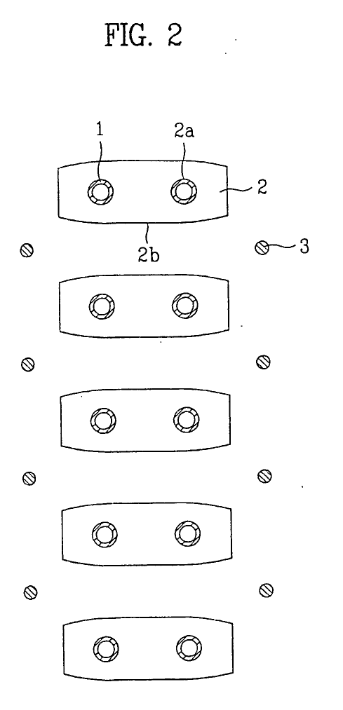

FIG. 3A illustrates a front view of a heat exchanger for a refrigerator in accordance with a preferred embodiment of the present invention;

FIG. 3B illustrates a section across a line II-II in FIG. 3A;

FIG. 4 illustrates a front view of a heat exchanger for a refrigerator having a variation of refrigerant tube arrangement in accordance with a preferred embodiment of the present invention;

FIG. 4B illustrates a section across a line III-III in FIG. 4A;

FIG. 5 illustrates a graph showing a remained amount of defrosted water per a unit fin area of the present invention and the related art;

FIG. 6 illustrates a graph showing a pressure loss vs. an operation time period of the present invention and the related art;

FIG. 7 illustrates a flow chart showing the steps of a method for fabricating a refrigerant tube for a heat exchanger in accordance with a preferred embodiment of the present invention;

FIGS. 8A and 8B illustrate front views showing states of refrigerant tube in the steps of a method for fabricating a refrigerant tube for a heat exchanger in accordance with a preferred embodiment of the present invention;

FIG. 9 illustrates a partial enlarged view of a coupled part of a refrigerant tube fabricated according to a method for fabricating a refrigerant tube for a heat exchanger in accordance with a preferred embodiment of the present invention;

FIG. 10 illustrates a partial section of the coupling part in FIG. 9; and

FIG. 11 illustrates a section across a line IV-IV in FIG. 9.

### BEST MODE FOR CARRYING OUT THE INVENTION

Reference will now be made in detail to the preferred embodiments of the present invention, examples of which-are illustrated in the accompanying drawings. In explaining the embodiments, same parts will be given the same names and reference symbols, and iterative explanations of which will be omitted.

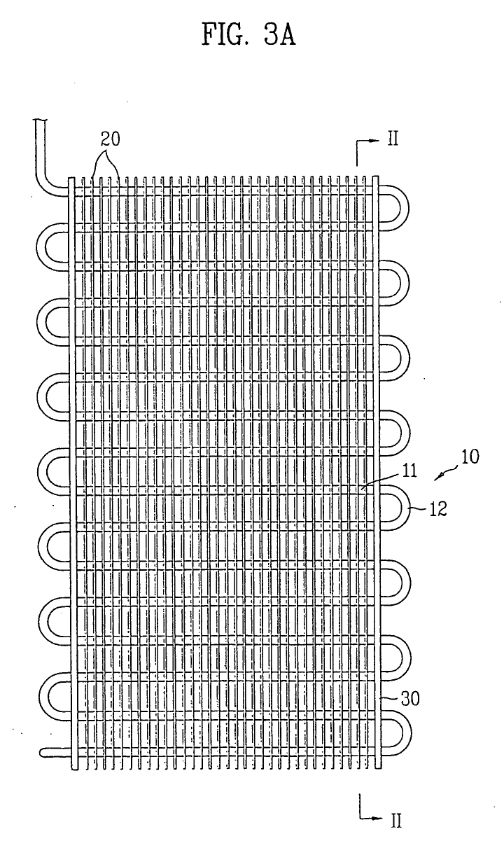

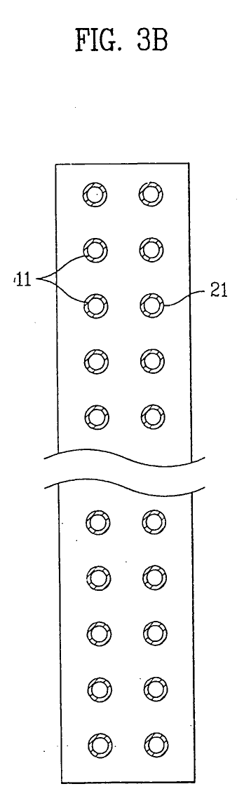

FIG. 3A illustrates a front view of a heat exchanger for a refrigerator in accordance with a preferred embodiment of the present invention, and FIG. 3B illustrates a section across a line II-II in FIG. 3A.

The heat exchanger of the present invention, on the whole, includes one of more than one refrigerant tube 10 for forming a flow passage of refrigerant supplied from a condenser, and a plurality of fins 20 fitted to the refrigerant tube 10. The heat exchanger also includes one pair of parallel reinforcing plates 30 fitted to opposite sides of the fitted fins 20.

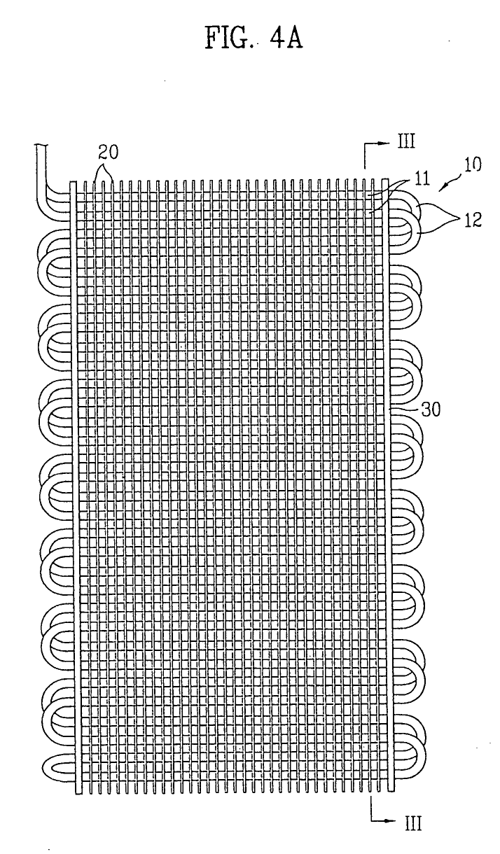

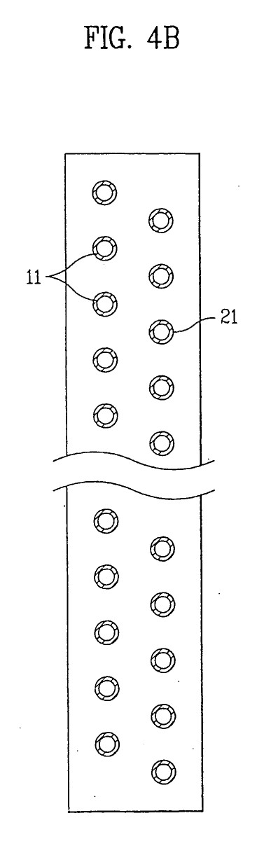

The refrigerant tube 10 includes a plurality of straight parts 11 spaced at fixed intervals, and a plurality of curved parts 12 each for connecting the straight parts 11. The refrigerant tubes 10, more specifically, the straight part 11 are substantially arranged perpendicular to direction of an air flow, and, as shown in FIG. 3B, one line of refrigerant tube 10 forms one column in a length direction of the heat exchanger. In this instance, as shown in FIGS. 3A and 33B, straight parts 11 in different columns may be arranged in parallel to each other in a horizontal direction. However, as shown in FIGS. 4A and 4b, for improvement of a performance of the heat exchanger, it is preferable that the straight parts 11 are arranged alternately, together with the through holes 21 in the fins. This alternate arrangement prevents bridging of frost grown between adjacent two refrigerant tubes 10, thereby avoiding an increase of flow resistance.

Each of the fins 20 is a straight flat plate of a fixed length, having a plurality of through holes 21 forming one, or more than one column along a length direction of the fin itself for coupling with the refrigerant tube 10. In more detail, the fins 20 are coupled with the straight parts of the refrigerant tubes 10 along lengths thereof at fixed intervals in parallel, extending to connect the straight parts 11 in the same column in succession as shown in FIGS. 3B and 4B. Accordingly, water (hereafter, defrosted water) formed at the refrigerant tubes 10 and fins 20 during the defrosting process is drained from the upper part to the lower part along the fins 10, smoothly. Moreover, the straight fin 20 of the present invention with a smaller number of lower edges than the related art discrete fin, reduces an amount of the defrosted water remained by surface tension.

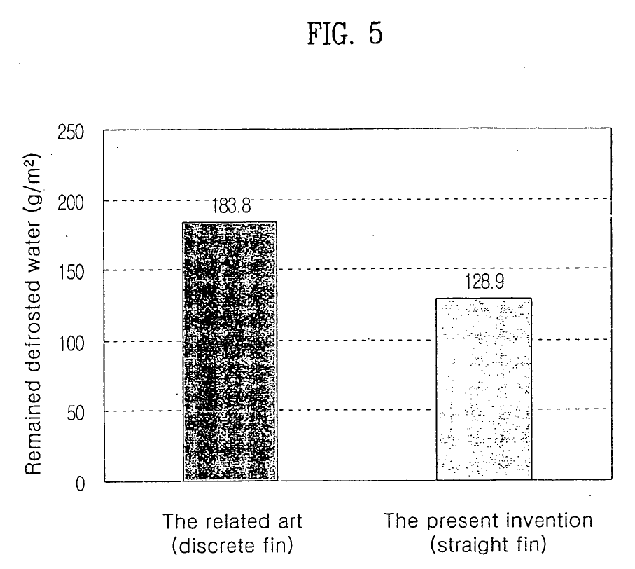

This trend can be verified by an actual experiment. FIG. 5 illustrates a graph showing a remained amount of defrosted water per a unit fin area of the present invention and the related art, where the discrete type fin (related art) and the straight fin (the present invention) are compared, in which respective amounts of the remained defrosted water are measured at a time after the defrosting process. As shown in FIG. 5, while 128.9 g/m² of defrosted water is remained in the case of the straight fin, 183.8 g/m² of defrosted water is remained in the case of the discrete type fin, more than the straight fin. In more detail, the amount of remained defrosted water of the straight fin is no more than 70% of the discrete type fin.

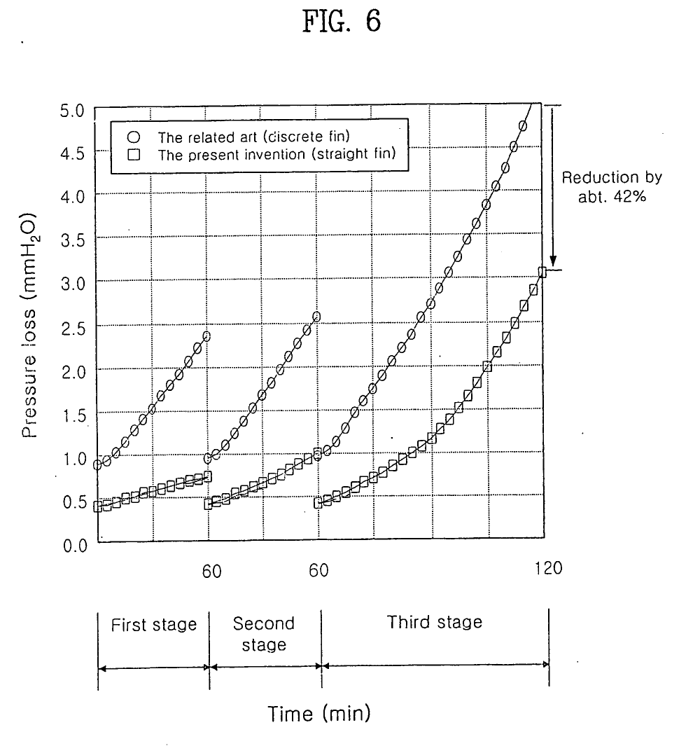

Moreover, the reduced amount of defrosted water is related to a pressure loss in the heat exchanger directly, which can be verified in FIG. 6 showing variation of pressure loss vs. operation time period, clearly. Alike the experiment of FIG. 5, this experiment compares heat exchangers having the discrete type fins and the straight fins applied thereto respectively, wherein the pressure loss is a pressure difference between an air entrance (the lower part of the heat exchanger) and an air exit (the upper part of the heat exchanger). In a first stage, variation of the pressure loss is measured during a dry heat exchanger carries out cooling for 60 minutes, and, in a second stage, variation of the pressure is measured during the heat exchanger carries out cooling for 60 minutes, after a certain time period of defrosting in succession to the first stage. Finally, in a third stage, variation of the pressure is measured during the heat exchanger carries out cooling for 120 minutes, after defrosting in succession to the second stage. As shown in FIG. 6, the pressure loss of the present invention is smaller than the related art in overall, and an increase ratio of the pressure loss expressed as a slope of the graph is also smaller. Actually, at ends of each of the stages, a pressure loss only approx. 42% of the related art is occurred in the present invention. This comes from a reduced flow resistance caused by reduced frost and reduced frost increase ratio owing to smaller amount of remained defrosted water. Along with this, the smaller amount of frosting allows smaller amount of heat transfer area reduction, resulting in no reduction of heat exchange rate.

Moreover, since the straight fin 20 of the present invention has an effect of continuously arranged discrete fins, a smaller size heat exchanger of the present invention can provide the same heat transfer area with the heat exchanger of the related art. Also, the application of the straight fins 20 provides a simple structured heat exchanger, and a simple assembly process since the straight fin 20 can be coupled with the straight parts of refrigerant tubes in the same column at a time easily.

At the end, the application of the straight fins 20 makes the heat exchanger of the present invention favorable in view of structure and performance compared to the related art heat exchanger of the discrete type fins 20.

In the meantime, because the straight fins 20 are coupled with entire straight parts of the refrigerant tubes 10 at a time, in general, the refrigerant tube 20 is fabricated by welding members formed separately instead of fabricating as one continuous (unitary) member. That is, after certain members of the refrigerant tube 20 are coupled with the fin 20 at first, other members of the refrigerant tube 20 are welded to the members coupled with the fin 20. In fabrication of the refrigerant tube 20, the refrigerant tube 20 is in general formed of aluminum, or copper, and zinc is used as a welding material, mostly. The material is a factor that fixes a performance of the refrigerant tube 20, and the following table shows properties of the materials.

| | Thermal conductivity | Weldability | Price | 1* |
|---|---|---|---|---|
| Al | Good | Average | Low | Low |
| Cu | Very good | Good | High | High |

1*: Risk of welding material (Zinc) corroded by potential difference.

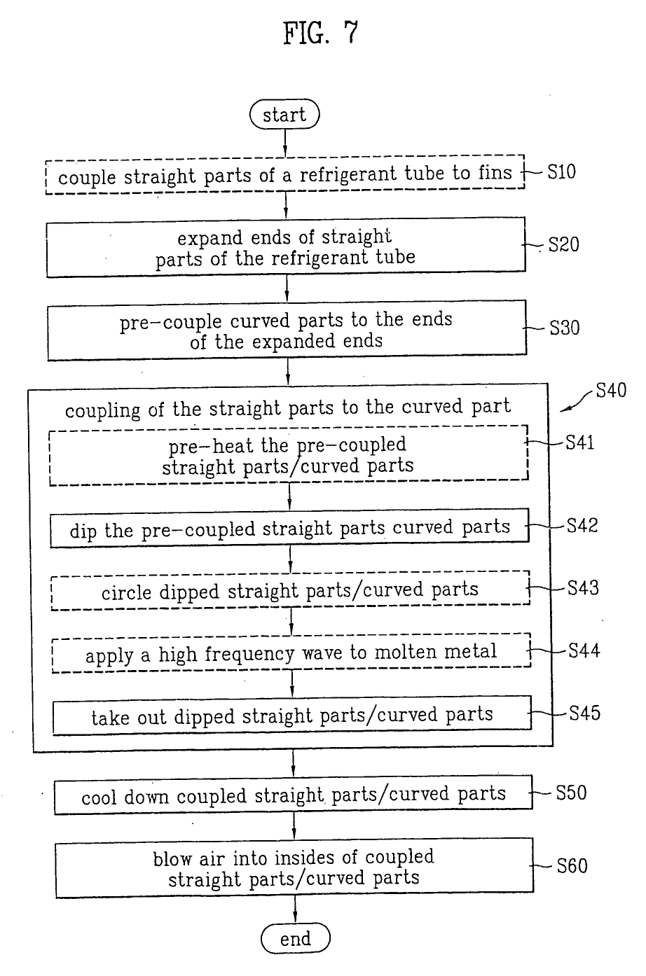

As shown in the table, since there is not a great difference in thermal conductivities, aluminum is preferable as a material of the refrigerant tube 10, taking price into account. Moreover, because air in the refrigerator contains a large amount of moist, salt, and acids, aluminum, which has, not only a low risk of welding material corrosion coming from potential difference, but also a high corrosion resistance, is further favorable compared to copper, except that the aluminum has a problem of a lower weldability in fabricating the refrigerant tube 10 of aluminum. That is, since aluminum is hardly fusible with other metal, application of a general welding method, in which a base metal is heated to a temperature higher than a melting point of the base metal, to aluminum welding is not feasible. The present invention provides a method for fabricating a refrigerant tube for supplementing the low weldability of aluminum, which will be explained with reference to FIG. 7.

FIG. 7 illustrates a flow chart showing the steps of a method for fabricating a refrigerant tube for a heat exchanger in accordance with a preferred embodiment of the present invention.

During fabrication of the refrigerant tube 20, ends of the straight part 11 of the refrigerant tube 10 are expanded each to have an inside and an outside diameters (S20).

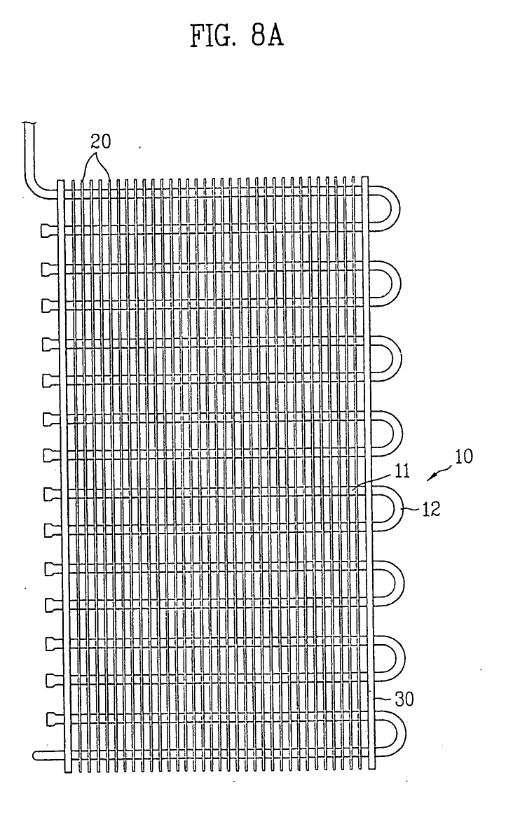

As explained, the refrigerant tube 10 has a plurality of members formed separately, i.e., the straight parts 11 and the curved parts 12, actually. Referring to FIGS. 8A-8b, for reducing a number of components of the refrigerant tube 10, it is preferable that only one side of the two sides of the curved parts 12 is formed separately, i.e., the straight parts 11 are formed with the other side of the curved part 12 as one unit. Therefore, in the expansion step (S20), ends of the straight part 11 not connected to the curved part 12 are expanded, and the curved part 12 formed separately is fitted to the expanded ends of the straight part 11.

In general, the ends may be expanded by inserting a tool therein, or by other methods. In order to prevent breakage of the ends, oil is supplied to the end during the expansion continuously, and air is blown to a periphery of the end for preventing entrance of other foreign matters into the straight part 11. For smooth infiltration of metal used as a bonding material during the straight part/curved part bonding, the end of the straight part 11 is expanded to a diameter more than 1.3 times of a diameter of an initial diameter. However, too much expansion may cause breakage of the end, it is more preferable that an inside diameter of the expanded end is limited to be 1.35-1.45 times of an initial inside diameter. The straight part 11 is expanded at least by 3 mm in a length direction from the end, which facilitates smooth infiltration of the metal the same as the case of the inside diameter.

In the meantime, once the ends are expanded, coupling of the fins 20 and the reinforcing plates 30 to the straight parts 11 becomes difficult. Therefore, before the expanding step (S20), it is preferable that the fins 20 and the reinforcing plates 30 are coupled to the straight parts formed as a unit with the curved part 12 (S20).

After the expanding step (S20) is finished, the straight parts 11 and the curved parts 12 are pre-coupled (S30). In this instance, as shown in FIG. 8B, the worker inserts ends of the curved part 12 into the expanded ends of the straight part. In this insertion, ends of the curved part 12 are pressed into the expanded ends of the straight part 11, partly. More precisely, the end of the curved part 12 is pressed into a part the expanded end of the straight part 11 is reduced to an initial diameter. According to this, the curved part 12 is not separated from the straight part 11 during final bonding.

After the pre-coupling step (S30), the straight part 11 and the curved part 12 are coupled completely by welding (S40).

In the coupling step (S40), the pre-coupled straight part 11 and the curved part 12 are dipped into molten metal (S42). In the dipping (S42), the assembly of the refrigerant tubes 10, the fins 20, and the reinforcing plates are hung from a hanger such that the pre-coupled straight part 11 and the curved parts face the molten metal, and dipped into the molted metal starting from the pre-coupled curved part 12. Therefore, all the pre-coupled straight parts 11 and the curved parts 12 can be dipped uniformly at a time. For adequate coating of the metal on the whole curved part 12 and the end of the straight part 11, it is preferable that the pre-coupled straight parts 11 and the curved parts 12 are dipped into the molten metal to a depth 15 mm from the end of the straight part 11.

The dipping step (S42) is carried out for 15 seconds, and it is appropriate that a temperature of the molten metal is approx. 400° C. The molten metal may be zinc, or other proper metal.

In the meantime, the curved parts 12 and the straight parts 11 may be pre-heated (S41) before the dipping step (S42). The pre-heating step (S41) is preferable since the metal is bonded to the curved parts 12 and the straight parts 11 well, thereby improving weldability.

By the way, in the dipping step (S42), the straight part 11 and the curved part 12 may be circled within the molten metal (S43). That is, the heat exchanger is slowly circled while the straight parts 11 and the curved parts 12 are dipped in the molten metal, for better infiltration of the metal between the straight parts 11 and the curved parts 12.

Moreover, a high frequency wave may be applied to the molten metal during the dipping step (S42) for shaking the molten metal, and accelerating the infiltration of the metal between the straight parts 11 and the curved parts 12. Moreover, the high frequency wave makes the straight parts 11 and the curved parts 12 to vibrate together, thereby making the metal infiltration more active.

By taking the dipped curved parts 12 and the straight parts 11 out of the molten metal (S45) after the foregoing series of steps (S41-S44) are carried out, the coupling step (S40) is finished. As a result of the dipping welding, exterior of the coupled straight parts 11 and the curved parts 12 are covered with a layer of the metal.

After the coupling step, the coupled straight parts 11 and the curved part 12 are cooled for a time period (S50) by a fan or the like for quick solidification of the metal. Then, air is blown into the coupled straight parts 11 and the curved parts 12, i.e., the refrigerant tube 10, for checking blocking of the refrigerant tube 10 and discharging foreign matters therein (S60).

As explained, because the dipping welding is applied to the method for fabricating a refrigerant tube of the present invention, the straight part 11 and the curved part 12 can be coupled without being heated over melting points. According to this, the refrigerant tube 10 can be formed of aluminum, resulting to drop of a production cost of the heat exchanger and improvement of corrosion resistance. It is understandable to a person skilled in this field of art that the method for fabricating a refrigerant tube is applicable not only to a refrigerant tube of aluminum, but also to a refrigerant tube of other material.

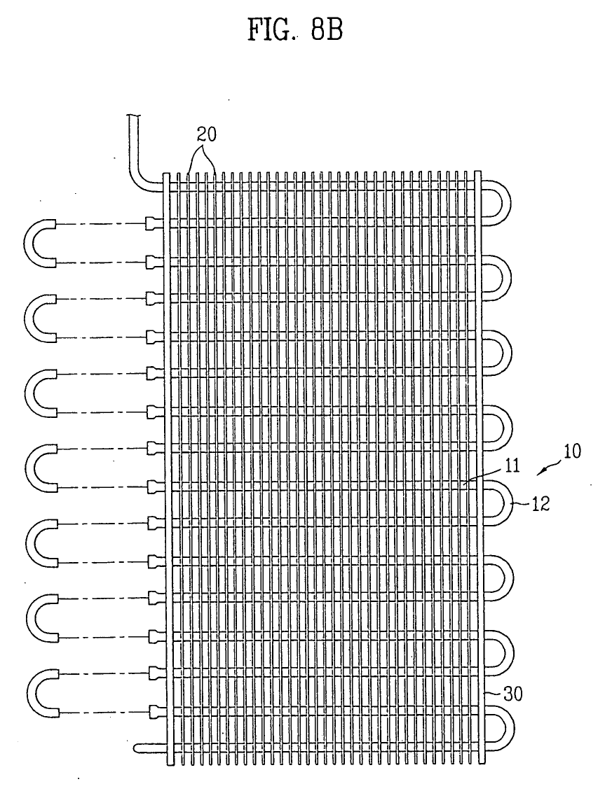

FIG. 9 illustrates a partial enlarged view of a coupled part of a refrigerant tube fabricated according to a method for fabricating a refrigerant tube in accordance with a preferred embodiment of the present invention, referring to which the form of the coupled part will be explained in detail.

As shown, the refrigerant tube 10 of the present invention has the coupled part coated with a metal layer on an outside of the refrigerant tube 10. That is, for coupling the metal layer 11, the straight part 11, and the curved part 12 from exterior, at least ends of the straight parts 11 are coated. Actually, the coupled part preferably includes the curved part 12, the ends of the straight part 11, and a metal layer 110 coated on the whole curved part 12, and the ends of the straight part 11. A length ‘D’ of the metal layer 110 extended from the end of the straight part 11 toward a center of the straight part 11 is 15 mm as explained in the dipping step (S42).

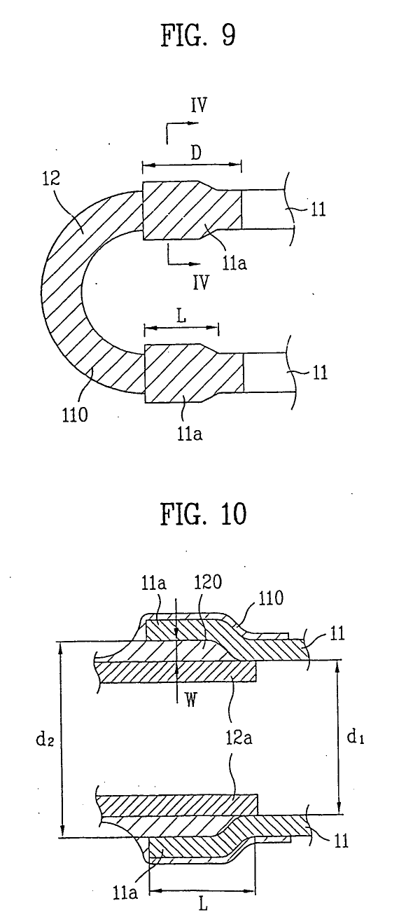

Due to the expansion step (S20), the coupled part further includes an expanded part 11a formed at the end of the straight part 11 the curved part 12 is inserted therein before being coupled. Moreover, as shown in FIGS. 9 and 10, in view of interior, the coupled part further includes an inserted part 12a, which is a part of the curved part 12 inserted in the expanded part, i.e., the end of the straight part 11, and a metallic stuffing material 120 stuffed between the expanded part 11a and the inserted part 12a.

An inside diameter d₂ of the expanded part 11a is 1.3 times of an initial outside diameter d₁ of the straight part for smooth infiltration of the stuffing material 120 between the expanded part 11a and the inserted part 12a. Actually,.for preventing breakage caused by excessive expansion, it is favorable that an inside diameter d₂ of the expanded part 11a is limited to 1.35-1.45 times of the initial diameter d₁.

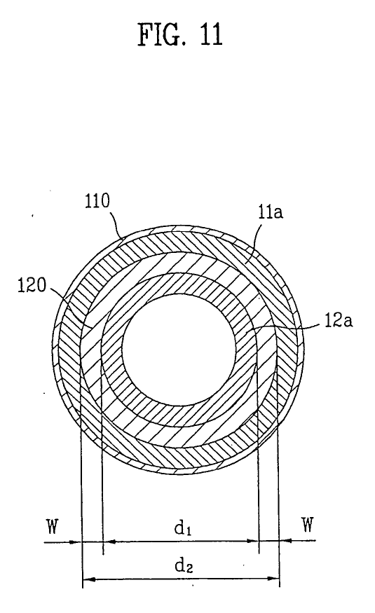

In the meantime, a ‘W’ is a gap between an inside surface of the expanded part 11a and an outside surface of the inserted part 12a, which is actually one half of a difference of the inside diameter d₂, and the inside diameter d₁ as shown in FIG. 11. The gap W and the length L of the expanded part 12a form a space for the metallic stuffing material 120, and are an important factor of a bonding strength. As explained, the gap ‘W’ actually has a value below 1 mm, since an increase of the inside diameter d2 of the expanded part 11a is limited to be within a certain range. Instead, the length L of the expanded part 11a is formed to be greater than 3 mm at the minimum, for providing an adequate bonding strength of the coupled part.

By the way, a general corrosion resistance layer is coated on all over a surface of the completed heat exchanger for preventing corrosion and spreading of the corrosion. Therefore, though not shown, the corrosion resistance layer is actually positioned on the metal layer 110 of the refrigerant tube 10, that may in general be a lacquer layer, or the like.

At the end, as the coupled part is coupled both by the internal metallic stuffing material 120 and the external metallic material layer 110, a coupling strength is enhanced and defects caused by leakage is reduced in comparison to a general coupling method (actually, a welding method). Moreover, the metallic stuffing material 120 is formed more uniformly by circling, or high frequency wave vibration, or the like during the coupling process, thereby enhancing effects of prevention of defects caused by leakage and strengthening a bonding force.

It will be apparent to those skilled in the art that various modifications and variations can be made in the heat exchanger for a refrigerator and method for fabricating a refrigerant tube of a heat exchanger for a refrigerator of the present invention without departing from the spirit or scope of the invention. Thus, it is intended that the present invention cover the modifications and variations of this invention provided they come within the scope of the appended claims and their equivalents.

Industrial Applicability

Basically, in the present invention, the application of continuous straight fins improves defrosted water drain capability, and suppresses formation of the frost from the source. Therefore, the present invention reduces a pressure loss (increased drain), improves a heat exchange efficiency and heat exchange performance.

In comparison to the related art discontinuous discrete fins, the fins of the present invention have a simple structure, that permits an easy assembly of the heat exchanger. That is, the heat exchanger of the present invention has a reduced number of components in comparison to the related art, and can dispense with separate forming and assembly process, that reduces a production cost and improves productivity. The application of straight fin permits reduction of a heat exchanger size for the same performance.

In the meantime, the application of the dipping welding in fabrication of the refrigerant tube permits to employ aluminum refrigerant tube, that permits reduction of production cost of the heat exchanger, and improvement of a corrosion resistance. Moreover, since the refrigerant tube has a uniform and strong coupled part, the refrigerant tube becomes to have an increased coupling strength and a reduced leak defects, that provides a reliability for a long time period use, at the end.

1. A heat exchanger for a refrigerator comprising:
a refrigerant tube having a plurality of straight parts and a plurality of curved parts each connecting the straight parts; and
a plurality of fins for coupling with the straight parts of the refrigerant tube through a plurality of through holes therein,
wherein the refrigerant tube includes coupled parts of the straight parts and the curved parts coated with a metal layer.

2. A heat exchanger as claimed in claim 1, wherein the metal layer is coated including ends of the straight parts.

3. A heat exchanger as claimed in claim 2, wherein the metal layer is coated on the whole curved parts and ends of the straight parts connected to the curved parts.

4. A heat exchanger as claimed in claim 3, wherein the metal layer is extended by 15 mm from the end of the straight part toward a center of the straight part.

5. A heat exchanger as claimed in claim 1, wherein the coupled part includes;
an expanded part at the end of the straight part,
an inserted part which is a part of the curved part inserted in the expanded part of the straight part, and
a metallic stuffing material stuffed in a space between the expanded part and the inserted part.

6. A heat exchanger as claimed in claim 5, wherein the expanded part has an inside diameter 1.3 times of an initial inside diameter of the straight part.

7. A heat exchanger as claimed in claim 6, wherein the expanded part has an inside diameter 1.35-1.45 times of an initial inside diameter of the straight part.

8. A heat exchanger as claimed in claim 5, wherein the expanded part has a length of minimum 3 mm.

9. A heat exchanger as claimed in claim 5, wherein a gap between an inside surface of the expanded part and the outside surface of the inserted part is below 1 mm.

10. A heat exchanger as claimed in claim 1, wherein the fin has a form of straight plate extended along a length direction of the heat exchanger.

11. A heat exchanger as claimed in claim 1, wherein the refrigerant tube is formed of aluminum.

12. A heat exchanger as claimed in claim 1, wherein the metal is zinc.

13. A heat exchanger as claimed in claim 1, wherein the refrigerant tube further includes a corrosion resistance layer coated on the metal layer.

14. A method for fabricating a refrigerant tube of a heat exchanger for a refrigerator, comprising the steps of:
expanding ends of straight parts of the refrigerant tube such that each of the ends has an inside and an outside diameters;
inserting ends of curved parts in expanded ends of the straight parts, to pre-couple the straight parts and the curved parts; and
coupling the pre-coupled straight parts and the curved part such that a metal layer covers a coupled part of the straight parts and the curved parts.

15. A method as claimed in claim 14, further comprising the step of coupling the straight parts and fins in advance before the step of expanding ends of straight parts.

16. A method as claimed in claim 14, wherein the ends of the curved parts are press fit to ends of the straight parts partially when the curved parts are inserted in the straight parts.

17. A method as claimed in claim 14, wherein the coupling step includes the steps of;
dipping the pre-coupled curved parts and straight parts in molten metal; and
taking the dipped curved part and the straight parts out of molten metal.

18. A method as claimed in claim 17, wherein the pre-coupled curved parts and the straight parts are dipped into the molten metal starting from the curved parts.

19. A method as claimed in claim 17, wherein the coupling step further includes the step of pre-heating the curved parts and the straight parts before the dipping step.

20. A method as claimed in claim 17, wherein the coupling step further includes the step of pre-heating the curved parts and the straight parts before the dipping step.

21. A method as claimed in claim 17, wherein the coupling step further includes the step of applying a high frequency wave to the molten metal during the dipping step.

22. A method as claimed in claim 14, further comprising the step of cooling down the coupled curved parts and straight parts after the coupling step.

23. A method as claimed in claim 14, further comprising the step of blowing air into insides of the coupled straight parts and curved parts after the coupling step.

24. A heat exchanger for a refrigerator, the heat exchanger having a refrigerant tube having a plurality of straight parts and a plurality of curved parts each connecting the straight parts, and a plurality of fins for coupling with the straight parts of the refrigerant tube through a plurality of through holes therein, wherein the refrigerant tube comprising:
an expanded part at each end of the straight part;
an inserted part which is a part of the curved part inserted in the expanded part of the straight part;
a metallic stuffing material stuffed in a space between the expanded part and the inserted part; and
a metal layer coated at least a part of surfaces of the expanded part and the curved part.

25. A heat exchanger as claimed in claim 24, wherein the metal layer is coated the whole curved part and the end of the straight part coupled to the curved part.

26. A heat exchanger as claimed in claim 24, wherein the fin has a form of straight plate extended along a length direction of the heat exchanger.

27. A heat exchanger as claimed in claim 24, wherein the refrigerant tube further includes a corrosion resistance layer coated on the metal layer.
